(19) United States
(12) Patent Application Publication
(10) Pub. No.: US 2009/0109926 A1
(43) Pub. Date: Apr. 30, 2009

(54) METHODS AND SYSTEMS FOR IN-ORDER DELIVERY DURING HANDOFF USING A TIMER IN MOBILE COMMUNICATIONS

(75) Inventor: Arnaud Meylan, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/260,350

(22) Filed: Oct. 29, 2008

Related U.S. Application Data
(60) Provisional application No. 60/984,352, filed on Oct. 31, 2007.

(51) Int. Cl. H04W 36/00

(52) U.S. Cl. 370/331

(57) ABSTRACT

Systems and methods for managing packetized data handoff between base stations in a mobile communication system are described. In one aspect, a timer is utilized to decide when to perform path switch from serving traffic forwarded by the source station to traffic received by the serving gateway, and to preserve, to a large degree, the packet order from a gateway device to a terminal, during the handoff between base stations. When handoff is indicated, the timer is started and only packets that are received by the source base station is forwarded to the terminal, while the timer runs. When the timer expires, the target station switches to transmit fresh packets received from the serving gateway. The timer can be adjusted “on the fly” and has been demonstrated to maximize TCP throughput as compared to a fixed switch timer.

### RELATED APPLICATIONS

The present patent application claims priority to Provisional Patent Application No. 60/984,352, titled “In-Order Delivery During Handoff Using a Heuristic Timer,” filed Oct. 31, 2007, which is assigned to the assignee hereof and filed by the inventors hereof and which is incorporated by reference herein.

### FIELD

This disclosure relates generally to wireless communications, and more particularly to gateway packet data handoff coordination in mobile systems.

### BACKGROUND

For the purposes of the present document, the following abbreviations apply:

AM Acknowledged Mode

AMD Acknowledged Mode Data

ARQ Automatic Repeat Request

BCCH Broadcast Control CHannel

BCH Broadcast CHannel

C- Control-

CCCH Common Control CHannel

CCH Control CHannel

CP Cyclic Prefix

CRC Cyclic Redundancy Check

CTCH Common Traffic Channel

D-BCH Dynamic Broadcast CHannel

DCCH Dedicated Control CHannel

DCH Dedicated CHannel

DL DownLink

DSCH Downlink Shared CHannel

DTCH Dedicated Traffic CHannel

FDD Frequency Division Duplex

L1 Layer 1 (physical layer)

L2 Layer 2 (data link layer)

L3 Layer 3 (network layer)

LI Length Indicator

LSB Least Significant Bit

MAC Medium Access Control

MBMS Multmedia Broadcast Multicast Service

MCCH MBMS point-to-multipoint Control CHannel

MRW Move Receiving Window

MSB Most Significant Bit

MSCH MBMS point-to-multipoint Scheduling CHannel

MTCH MBMS point-to-multipoint Traffic Channel

P-BCH Primary Broadcast CHannel

PCCH Paging Control Channel

PCFICH Physical Control Format Indicator CHannel

PCH Paging Channel

PDCCH Physical Downlink Control CHannel

PDU Protocol Data Unit

PHY PHYsical layer

PHICH Physical Hybrid-ARQ Indicator CHannel

PhyCH Physical CHannels

RACH Random Access Channel

RE Resource Element

RS Reference Signal

RLC Radio Link Control

RoHC Robust Header Compression

RRC Radio Resource Control

SAP Service Access Point

SDU Service Data Unit

SHCCH SHared channel Control CHannel

SN Sequence Number

SUFI SUper FIeld

TCH Traffic CHannel

TDD Time Division Duplex

TFI Transport Format Indicator

TM Transparent Mode

TMD Transparent Mode Data

TTI Transmission Time Interval

U- User-

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

### SUMMARY

The present disclosure is directed to systems and methods for managing packetized data handoff between base stations in a mobile system, and variations thereof.

In one of various aspects of the disclosure, a method for controlling packet path switch from forwarded packets to fresh packets for transmission to a terminal during a source station to a target station handoff is provided, the method comprising: starting a timer upon a handover indication; receiving packets forwarded by a source station and transmitting them to a terminal, while the timer is running; restarting the timer whenever a forwarded packet is received and the timer has not expired; and switching to transmission to the terminal of fresh packets received from an access gateway after the timer has expired.

In one of various aspects of the disclosure, a wireless communication system for preserving packet order by controlling packet path to a terminal during a source station to a target station handoff is provided, the system comprising: a communication network; a gateway providing packet data to the communication network; a source station operating in the communication network; a target station operating in the communication network; a communication link between the source station and the target station; a terminal in the communication network; and a timer, which is initiated upon a handover indication, wherein packets sent by the source station from the gateway are forwarded to the terminal by the target station until a timeout of the timer occurs, and whenever a new packet is received by the target station and if the timer has not expired, the timer is restarted.

In one of various aspects of the disclosure, a wireless communication system for controlling packet path to a communication device during a handoff is provided, the system comprising: means for providing packets; means for receiving wirelessly transmitted packets; a first means for at least one of wirelessly or non-wirelessly transmitting received packets; a second means for wirelessly transmitting received packets; and means for timing being initiated upon a handover indication, wherein received packets are sent by the first means to the second means to be forwarded to the means for receiving wirelessly transmitted packets until a timeout of the means for timing occurs, and whenever a new packet is received by the second means and the means for timing has not expired, the means for timing is restarted.

In one of various aspects of the disclosure, a computer program product is provided comprising: a computer-readable medium comprising: code for starting a timer upon a handover indication between a source station and a target station in a mobile communication environment; code for receiving packets sent by the source station by the target station; code for forwarding information of the received packets sent by the source station to a terminal by the target station until a timeout of the timer occurs; and code for whenever a new packet is received and the timer has not expired, the timer is restarted.

### BRIEF DESCRIPTION OF THE DRAWING

FIG. 1 is an illustration of a multiple access wireless communication system.

FIG. 2 is a block diagram of an embodiment of a transmitter system and a receiver system.

FIG. 3 is an illustration of a multiple access wireless communication system including multiple cells.

FIG. 4 is a block diagram of a communication system containing a gateway, a source station, a target station, and a terminal.

FIG. 5 depicts relative performances for a simulation with good channel conditions.

FIG. 6 depicts relative performances for a simulation with poor channel conditions.

FIG. 7 is a flowchart outlining a timer approach.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with an access terminal. An access terminal can also be called a system, subscriber unit, subscriber station, mobile station, mobile, remote station, remote terminal, mobile device, user terminal, terminal, wireless communication device, user agent, user device, or user equipment (UE). An access terminal can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to or utilizing a wireless modem. Moreover, various embodiments are described herein in connection with a base station. A base station can be utilized for communicating with access terminal(s) and can also be referred to as an access point, Node B, eNode B (eNB), or some other terminology. Depending on the context of the descriptions provided below, the term Node B may be replaced with eNB and/or vice versus as according to the relevant communication system being employed.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

An orthogonal frequency division multiplex (OFDM) communication system effectively partitions the overall system bandwidth into multiple (N_{F}) subcarriers, which may also be referred to as frequency subchannels, tones, or frequency bins. For an OFDM system, the data to be transmitted (i.e., the information bits) is first encoded with a particular coding scheme to generate coded bits, and the coded bits are further grouped into multi-bit symbols that are then mapped to modulation symbols. Each modulation symbol corresponds to a point in a signal constellation defined by a particular modulation scheme (e.g., M-PSK or M-QAM) used for data transmission. At each time interval that may be dependent on the bandwidth of each frequency subcarrier, a modulation symbol may be transmitted on each of the N_{F} frequency subcarrier. OFDM may be used to combat inter-symbol interference (ISI) caused by frequency selective fading, which is characterized by different amounts of attenuation across the system bandwidth.

A multiple-input multiple-output (MIMO) communication system employs multiple (N_{T}) transmit antennas and multiple (N_{R}) receive antennas for data transmission. A MIMO channel formed by the N_{T} transmit and N_{R} receive antennas may be decomposed into N_{S} independent channels, with N_{S}≦min {N_{T}, N_{R}}. Each of the N_{S} independent channels may also be referred to as a spatial subcarrier of the MIMO channel and corresponds to a dimension. The MIMO system can provide improved performance (e.g., increased transmission capacity) if the additional dimensionalities created by the multiple transmit and receive antennas are utilized.

For a MIMO system that employs OFDM (i.e., a MIMO-OFDM system), N_{F} frequency subcarriers are available on each of the N_{S} spatial subchannels for data transmission. Each frequency subcarrier of each spatial subchannel may be referred to as a transmission channel. There are N_{F}·N_{S} transmission channels thus available for data transmission between the N_{T} transmit antennas and N_{R} receive antennas.

For a MIMO-OFDM system, the N_{F} frequency subchannels of each spatial subchannel may experience different channel conditions (e.g., different fading and multipath effects) and may achieve different signal-to-noise-and-interference ratios (SNRs). Each transmitted modulation symbol is affected by the response of the transmission channel via which the symbol was transmitted. Depending on the multipath profile of the communication channel between the transmitter and receiver, the frequency response may vary widely throughout the system bandwidth for each spatial subchannel, and may further vary widely among the spatial subchannels.

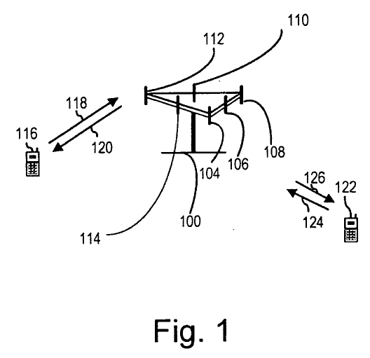

Referring to FIG. 1, a multiple access wireless communication system according to one embodiment is illustrated. An access point 100 (AP) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access point. In the embodiment, antenna groups each are designed to communicate to access terminals in a sector, of the areas covered by access point 100.

In communication over forward links 120 and 126, the transmitting antennas of access point 100 utilize beamforming in order to improve the signal-to-noise ratio of forward links for the different access terminals 116 and 124. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as an access point, a Node B, or some other terminology. An access terminal may also be called an access terminal, user equipment (UE), a wireless communication device, terminal, access terminal or some other terminology.

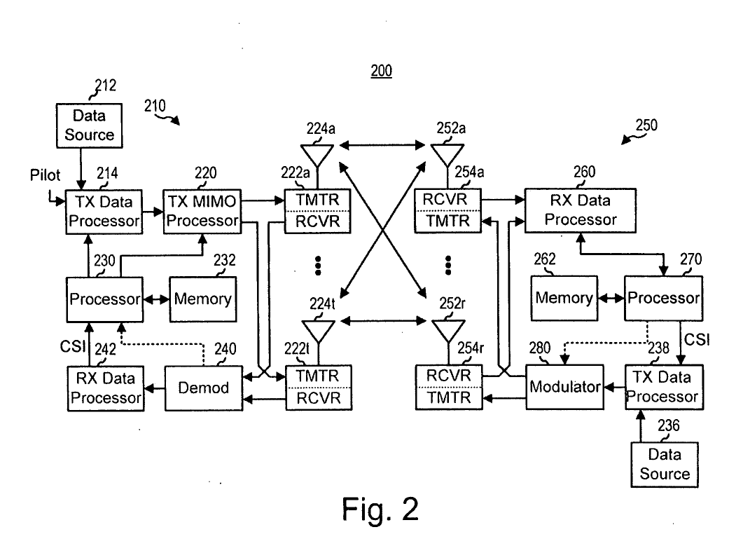

FIG. 2 is a block diagram of an embodiment of a transmitter system 210 (also known as the access point) and a receiver system 250 (also known as access terminal) in a MIMO system 200. At the transmitter system 210, traffic data for a number of data streams is provided from a data source 212 to transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230 which may have memory 232 attached.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX NIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion. The processor 270 may be coupled to supporting memory 262.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights and then processes the extracted message.

In an aspect, logical channels are classified into Control Channels and Traffic Channels. Logical Control Channels comprises Broadcast Control Channel (BCCH), which is DL channel for broadcasting system control information. Paging Control Channel (PCCH), which is DL channel that transfers paging information. Multicast Control Channel (MCCH), which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. In one aspect, Logical Traffic Channels can comprise a Dedicated Traffic Channel (DTCH), which is a point-to-point bi-directional channel, dedicated to one UE, for the transfer of user information. Also, a Multicast Traffic Channel (MTCH) for Point-to-multipoint DL channel for transmitting traffic data.

In an aspect, Transport Channels are classified into DL and UL. DL Transport Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), a Uplink Shared Data Channel (UL-SDCH) and plurality of PHY channels. The PHY channels comprises a set of DL channels and UL channels.

The DL PHY channels comprises:

Common Pilot Channel (CPICH)

Synchronization Channel (SCH)

Common Control Channel (CCCH)

Shared DL Control Channel (SDCCH)

Multicast Control Channel (MCCH)

Shared UL Assignment Channel (SUACH)

Acknowledgement Channel (ACKCH)

DL Physical Shared Data Channel (DL-PSDCH)

UL Power Control Channel (UPCCH)

Paging Indicator Channel (PICH)

Load Indicator Channel (LICH)

The UL PHY Channels comprises:

Physical Random Access Channel (PRACH)

Channel Quality Indicator Channel (CQICH)

Acknowledgement Channel (ACKCH)

Antenna Subset Indicator Channel (ASICH)

Shared Request Channel (SREQCH)

LL Physical Shared Data Channel (UL-PSDCH)

Broadband Pilot Channel (BPICH)

In an aspect, a channel structure is provided that preserves low PAR (at any given time, the channel is contiguous or uniformly spaced in frequency) properties of a single carrier waveform.

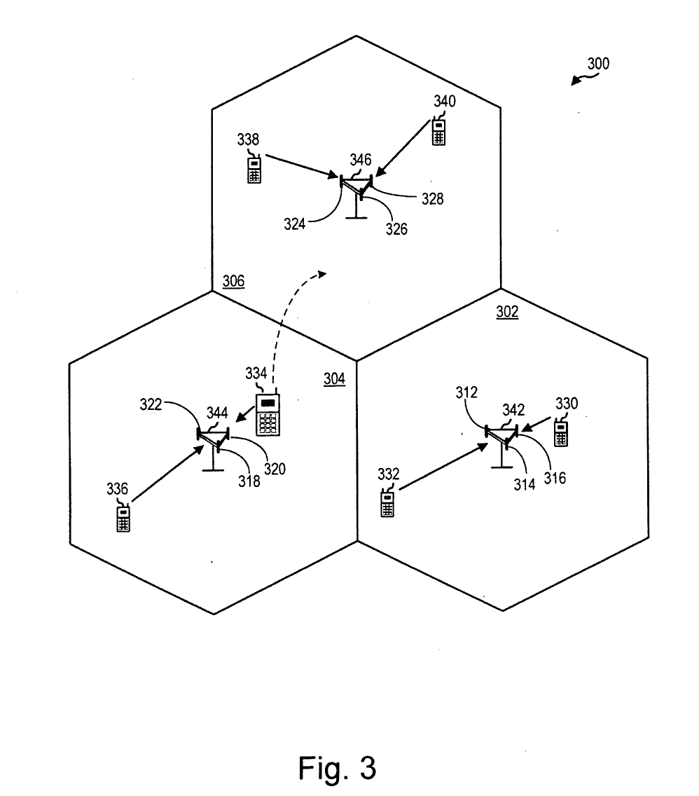

Referring to FIG. 3, a multiple access wireless communication system 300 according to one aspect is illustrated. The multiple access wireless communication system 300 includes multiple regions, including cells 302, 304, and 306. In the aspect of FIG. 3, each cell 302, 304, and 306 may include a Node B that includes multiple sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each may correspond to a different sector. In cell 306, antenna groups 324, 326, and 328 each may correspond to a different sector.

Each cell 302, 304 and 306 can include several wireless communication devices, e.g., User Equipment or UEs, which can be in communication with one or more sectors of each cell 302, 304 or 306. For example, UEs 330 and 332 can be in communication with Node-B 342, UEs 334 and 336 can be in communication with Node B 344, and UEs 338 and 340 can be in communication with Node B 346.

The General Packet Radio Services (GPRS) system is a ubiquitous mobile phone system is used by GSM Mobile phones for transmitting IP packets. The GPRS Core Network (an integrated part of the GSM core network) is a part of the GPRS system that provides support for WCDMA based 30 networks as well as Long Term Evolution (LTE) based 4G networks. The GPRS Core Network can provide mobility management, session management and transport for Internet Protocol packet services in GSM and WCDMA networks. LTE comprises EUTRA (Evolved Universal Terrestrial Radio Access) and EUTRAN (Evolved Universal Terrestrial Radio Access Network).

GPRS Tunneling Protocol (GTP) is an IP protocol of the GPRS core network. GTP can enable end users of a GSM, WCDMA or LTE network to move from place to place while continuing to connect to the Internet as if from one location at a particular Gateway GPRS Support Node (GGSN). It does this by carrying subscriber's data from a subscriber's current Serving GPRS Support Node (SGSN) to the GGSN which is handling the subscriber's session. Three forms of GTP are used by the GPRS core network including (1) GTP-U: for transfer of user data in separated tunnels for each PDP context; (2) GTP-C: for control reasons such as setup and deletion of PDP contexts and verification of GSN reachability updates as subscribers move from one SGSN to another; and (3) GTP′: for transfer of charging data from GSNs to the charging function.

GPRS Support Nodes (GSN) are network nodes that support the use of GPRS in the GSM core network. There are two key variants of the GSN including Gateway GPRS Support Node (GGSN) and Serving GPRS Support Node (SGSN).

A GGSN can provide an interface between the GPRS backbone network and the external packet data networks (radio network and the IP network). It can convert GPRS packets coming from the SGSN into the appropriate packet data protocol (PDP) format (e.g. IP or X.25) and send the converted packets them to the corresponding packet data network. In the other direction, PDP addresses of incoming data packets may be converted to the GSM address of a destination user. The readdressed packets may then be sent to the responsible SGSN. For this purpose, the GGSN can store the current SGSN address of the user and his or her profile in its location register. The GGSN can provide IP address assignment and is generally the default router for a particular UE.

In contrast, an SGSN can be responsible for the delivery of data packets from/to mobile stations within its geographical service area. The tasks of an SGSN can include packet routing and transfer, mobility management, logical link management, authentication and charging functions.

Continuing, the GPRS tunneling protocol for the user plane (GTP-U) layer may be used on the user-plane (U-plane) and is useful for transmitting user data in a packet switched area. Packet switched networks in the Universal Mobile Telecommunications System (UMTS) are based on GPRS, and therefore, the GTP-U may also be used in the UMTS. UMTS is one of the third-generation (3G) cell phone technologies. UMTS is sometimes referred to as 3GSM, which hints at both its 3G background and the GSM standard for which it was designed to succeed.

Again returning to FIG. 3, it should be appreciated that there will be instances where a one Node B (or more appropriately for these particular telecom standards “eNB”) will hand communication off to a second eNB. For the purpose of this disclosure, the eNB handing over communication with a UE may be referred to as the “source eNB” while the eNB gaining access to the UE may be referred to as the “target eNB.” Handoff or handover refer to the process of adding or removing a station from the serving station set. Handoff or handover may be initiated by the network, or by the terminal—also known as terminal-based mobility.

For Long Term Evolution (LTE) communication systems, it may be beneficial to guarantee that corresponding IP packets, or Packet Data Control Protocol (PDCP) service data units (SDUs) are delivered “in-order” during handover. LTE communications systems, such as UMTS may use PDCP (Packet Data Convergence Protocol) as one of the layers of the Radio Traffic Stack. PDCP can perform a variety of functions including IP header compression and decompression, transfer of user data and maintenance of sequence numbers (SNs).

Similarly, the TCP protocol works best if packets for a particular message are received in the appropriate order. Otherwise, the overall data transfer rate tends to suffer. Hence, it should be appreciated that PDCP should packetize TCP packets in order.

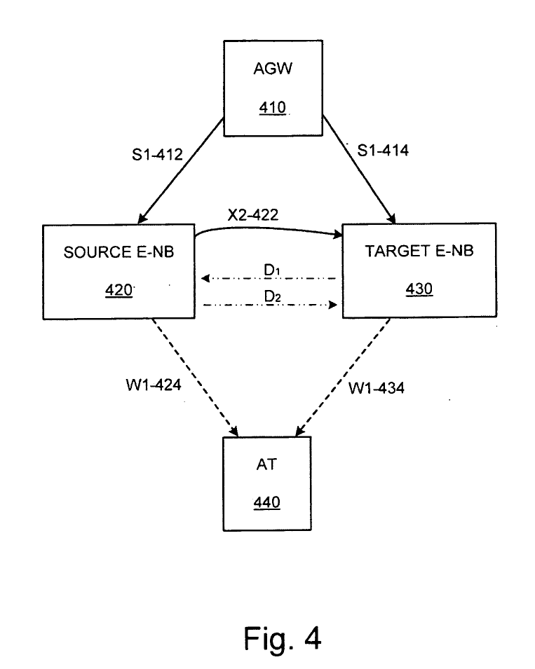

Continuing to FIG. 4, a block diagram of a communication system is depicted. As shown in FIG. 4, the communication system includes an access gateway (AGW) 410, a source eNB 420, a target eNB 430 and an User Equipment (UE) 440. Also shown in FIG. 4, both the source eNB 420 and the target eNB 430 are connected to the AGW 410 via respective S1 links S1-412 and S1-414, the source eNB 420 and target eNB 430 are coupled together via link X2-422, and the source eNB 420 and the target eNB 430 may each be in contact with the AT 440 via respective wireless links W1-424 and W1-434.

It should be appreciated that during handover, the target eNB 430 may receive packets from both the source eNB 420 and the AGW 410. Unfortunately, during a handoff, the target eNB 430 may not know which or how many IP packets have been sent from the AGW 410 to the source eNB 420, which and how many IP packets have been forwarded from the source eNB 420 to the AT 440, and which and how many IP packets may need to be received from the AGW 410.

During handoff, in order to ensure ordered IP packet delivery the target eNB 430 must decide when to switch from serving packets forwarded by the source eNB 420 to serving packets received directly from the AGW in order to assign the PDCP sequence number (PDCP-SN) to those packets correctly to ensure they are delivered in-order at the UE 440—ordered with only a minimum DL data delay. However, this may require the target eNB 430 to coordinate IP packets such that they are timely received and in order.

A first possible solution might be to alter the standard protocols of the wired side of an LTE or other wireless packet data system. For example, the last packet sent by a source eNB 420 to a target eNB 430 might be marked to inform the target eNB 430 that it can then switch to using packets from an AGW 410 or other device. For LTE, this may require GTP-SN, tagging and PDCP support, which may or may not be available for a particular deployment.

A second solution is to implement a timer. In various embodiments, such timer may be initially set to some time T1 when the target eNB 430 sends HANDOVER REQUEST ACK command to the source eNB 420.

While the timer runs, the target eNB 430 can send to the UE 440 only that information provided by packets send by the source eNB 420 over link X2-422.

Should the timer expire, then the target eNB 430 may send only that information provided by packets send by the AGW 410 over link S1-414. If subsequent packets are received from the source eNB 420 over link X2-422, they may be dropped to avoid sending them out of order.

Such a fixed-value timer may not be appropriate because there is no one-value-fits-all timer. A short timer may force a target eNB 430 to drop forwarded packets (i.e., packets from the source eNB 420) or send them out of order. However, an overly-long timer would idle the air interface, and an optimal timer value would be a function of a message queue-size in a target eNB 430, which in turn is a function of channel conditions, handoff frequency and type of application.

A third solution is to implement an adjustable timer, that is, having heuristic capabilities. In various embodiments, a timer used by the target eNB 430 may be initially set to some time DELTA when the target eNB 430 sends HANDOVER REQUEST ACK command to the source eNB 420. Generally, the value DELTA may be determined based on the sum of transmission time, propagation delays D1 and D2, and processing time D3 (depicted in FIG. 4) between the source eNB 420 and the target eNB 430 according to Eq (1) below:

DELTA=D1+D2+D3+Tau, Eq (1)

where Tau is some performance buffer time.

Note that the round-trip propagation between the target eNB 430 and the source eNB 420 may be sampled using a standard “ping” command or equivalent. Accordingly, should a ping command measure the sum of the transmission time and propagation delays of D1=D2=10 ms, and assuming a buffer time of 5 ms, then DELTA may be set to D1+D2+Tau=25 ms. The size of the ping message may be selected to match the size of the expected user's data packets that will be forwarded at handoff. Or have the Maximal Transport Unit size allowed on that interface in order to get an upper bound.

Note that, in various embodiments, the time DELTA of the timer may be dynamically adjusted, both message by message and packet by packet, should packets be received by the target eNB 430 in times appreciably different from an earlier estimate. This may be the inclusion of a positive or negative value to DELTA.

The timer is used by the target eNB 430 to decide when to switch from serving traffic forwarded by the source eNB 420 (over link X2-422) to traffic received via link 414 from the servicing gateway AGW 410. Should a packet be received during the DELTA time period, then the timer may be restarted.

Should the timer expire, then any packets forwarded from the source eNB 420 over link X2-422, may be dropped or sent logically out of order, depending on what may be the less disruptive to the application. After the timer expires, the target eNB 430 switches to send traffic directly received by AGW 410.

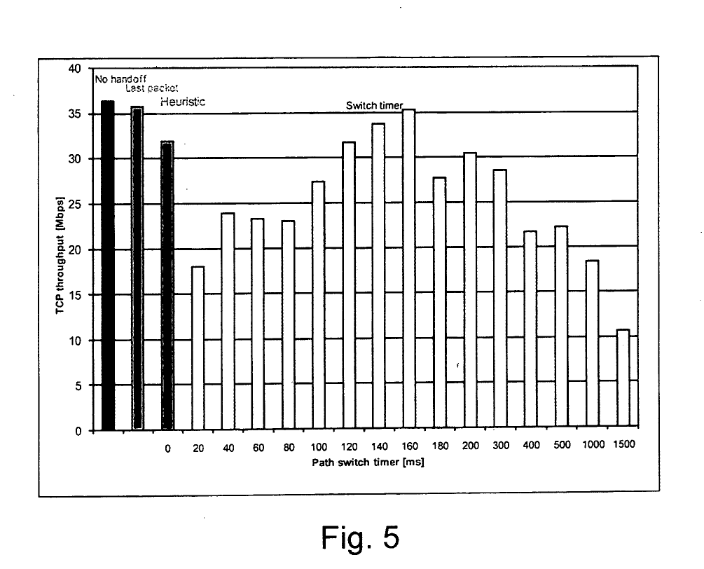

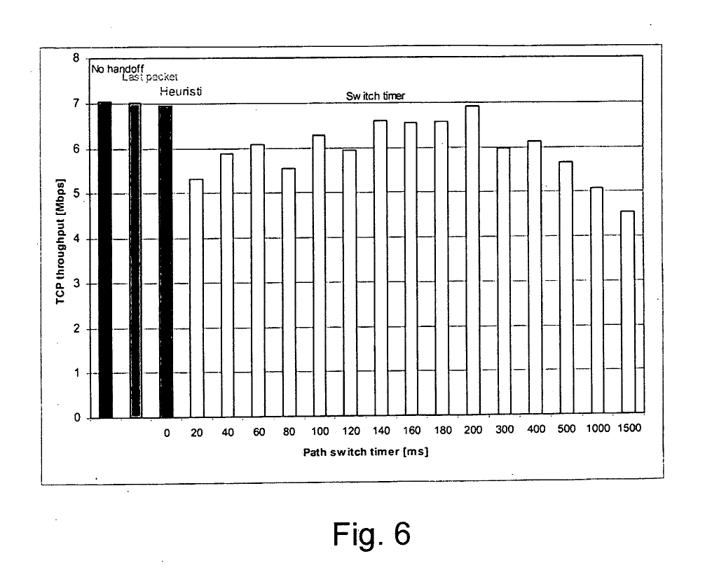

FIGS. 5 and 6 depict relative performance for a simulation of the three approaches outlines above, with FIG. 5 representing typical good channel conditions and FIG. 6 representing typical poor channel conditions. The simulated conditions include 12 handoffs between 17 and 56 seconds, the target eNB waits initially for 1 “round trip” time (RTT) (here assumed to be 40 ms), then every time a tunneled packet is found, the timer is restarted with a value of 1 RTT (40 ms). This is adjustable or adjusted timer plot is labeled as “Heuristic” in the plots. The far left plot (“No handoff”) depicts a situation where no handoff occurred and thus may represent a theoretical limit. The “Last packet” plot depicts the first solution described above where the last packet from a source eNB is marked according to a theoretical standard. The fifteen plots to the right of the “Last packet” plot depict performance associated with the simple timer approach for various timer values.

As can be seen by FIGS. 5 and 6, switching based on “Last packet” provides the best performance at the cost of standard support, which may not be available or implemented. On the other hand, “heuristic” switching requires no standard support and performs reasonably well in most scenarios. The fixed timer approach appears “hit or miss” at best depending on the timer value.

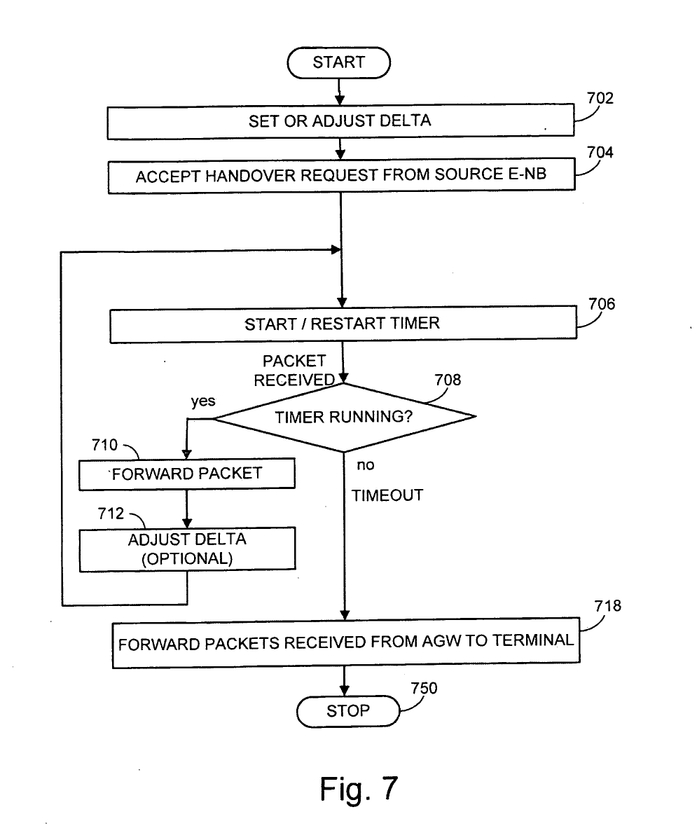

FIG. 7 is a flowchart outlining an exemplary operation for use with a timer having heuristic capabilities. The process starts in step 702 where a value “DELTA” of a timer is set or adjusted. Next, in step 704, a handover procedure is started from a source eNB to a target eNB.

In step 706, the timer is then started for use by the target eNB—generally in response to an appropriate acknowledgment signal sent by the target eNB.

In step 708, a determination is made as to whether a packet was received from the source eNB or whether the timer “timed out”. If a packet was timely received, control jumps to step 710 where the information in the packet is forwarded to an UE, and next to step 712, where the value DELTA is optionally adjusted. Control then jumps back to step 706 where the timer is restarted.

If a timeout occurs, control continues to step 718 where the target eNB is set to transmit packets sent by the appropriate gateway, stop transmitting packets received from the source eNB, and control continues to step 750 where the process stops.

While the above embodiments are characterized using source and target eNBs, it should be appreciated that other base stations and/or other types of network intermediaries may be implemented that are capable of performing the above-described functions, as well as other devices or systems for performing the AGW functions. Additionally, while the above embodiments can be implemented in LTE, other mobile communication paradigms such as RAN3/EUTRAN, WiMAX LTE, WLAN, and so forth may find the exemplary methods and systems disclosed herein to be advantageous. Accordingly, in the spirit of the above disclosure, it should be understood that modifications and/or changes may be made to various elements and steps without departing from the desired objectives.

The techniques described herein may be implemented by various means. For example, these techniques may be implemented in hardware, software, or a combination thereof. For a hardware implementation, the processing units used for channel estimation may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes may be stored in a computer-readable medium or a memory unit and executed by the processors.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for controlling packet path switch from forwarded packets to fresh packets for transmission to a terminal during a source station to a target station handoff, the method comprising:
starting a timer upon a handover indication;
receiving packets forwarded by a source station and transmitting them to a terminal, while the timer is running;
restarting the timer whenever a forwarded packet is received and the timer has not expired; and
switching to transmission to the terminal of fresh packets received from an access gateway after the timer has expired.

2. The method of claim 1, further comprising:
not transmitting to the terminal received forwarded packets from the source station after timeout of the timer occurs; and
forwarding information of the received fresh packets to the target station for transmission by the target station to the terminal.

3. The method of claim 1, further comprising setting a value of the timer by taking into account at least one of a round trip propagation delay, transmission delay and processing delay between the source station and the target station.

4. The method of claim 3, further comprising adjusting the value of the timer after the handoff has started.

5. The method of claim 1, wherein the target station is an eNB device.

6. The method of claim 1, wherein the source station is an eNB device.

7. A processor comprising circuitry for performing the method of claim 1, said processor provided as a chipset including at least one monolithic integrated circuit.

8. A wireless communication system for preserving packet order by controlling packet path to a terminal during a source station to a target station handoff, the system comprising:
a communication network;
a gateway providing packet data to the communication network;
a source station operating in the communication network;
a target station operating in the communication network;
a communication link between the source station and the target station;
a terminal in the communication network; and
a timer, which is initiated upon a handover indication, wherein packets sent by the source station from the gateway are forwarded to the terminal by the target station until a timeout of the timer occurs, and whenever a new packet is received by the target station and if the timer has not expired, the timer is restarted.

9. The system of claim 8, wherein the target station drops packets sent by the source station after timeout of the timer occurs and forwards packets received from the gateway to the terminal.

10. The system of claim 8, wherein a value of the timer is based on at least a round trip propagation delay between the source station and the target station.

11. The system of claim 10, wherein the value of the timer is adjusted after the handoff has started.

12. The system of claim 8, wherein the target station is an eNB device.

13. The system of claim 8, wherein the source station is an eNB device.

14. The system of claim 8, wherein the communication network is capable of operating under at least one of LTE, QFT LTE CSM, WiMAX LTE, and WLAN.

15. A wireless communication system for controlling packet path to a communication device during a handoff, the system comprising:
means for providing packets;
means for receiving wirelessly transmitted packets;
a first means for at least one of wirelessly or non-wirelessly transmitting received packets;
a second means for wirelessly transmitting received packets; and
means for timing being initiated upon a handover indication, wherein received packets are sent by the first means to the second means to be forwarded to the means for receiving wirelessly transmitted packets until a timeout of the means for timing occurs, and whenever a new packet is received by the second means and the means for timing has not expired, the means for timing is restarted.

16. The wireless communication system of claim 15, wherein the second means drops packets sent by the first means after timeout of the means for timing occurs and forwards packets received from the means for providing packets to the means for receiving wirelessly transmitted packets.

17. A computer program product comprising:
a computer-readable medium comprising:
code for starting a timer upon a handover indication between a source station and a target station in a mobile communication environment;
code for receiving packets sent by the source station by the target station;
code for forwarding information of the received packets sent by the source station to a terminal by the target station until a timeout of the timer occurs; and
code for whenever a new packet is received and the timer has not expired, the timer is restarted.

18. The computer program product of claim 17, further comprising:
code for dropping received packets sent by the source station after timeout of the timer occurs; and
code for forwarding information of packets received from a gateway by the target station to be forwarded by the target station to the terminal.

19. The computer program product of claim 17, further comprising code to set a value of the timer by taking into account a round trip propagation delay between the source station and the target station.

20. The computer program product of claim 19, further comprising code for adjusting the value of the timer after the handoff has started.
